(19) United States
(12) Patent Application Publication
(10) Pub. No.: US 2026/0253183 A1
(43) Pub. Date: Aug. 27, 2026

(54) SYSTEM AND METHOD FOR GENERATING A HIGH-RESOLUTION IMAGE

(71) Applicant: Samsung Electronics Co., Ltd., Suwon-si (KR)

(72) Inventors: Kunal SWAMI, Bengaluru (IN); Rajeev Vijendra IRNY, Bengaluru (IN); Raghu Vamsi Krishna CHITTERSU, Bengaluru (IN); Sameer Suhail MOHAMMAD, Bengaluru (IN); Saketh SHARMA, Bengaluru (IN); Alok Shankarlal SHUKLA, Bengaluru (IN); Swarnim SHUKLA, Bengaluru (IN); Hemanth PIDAPARTHY, Bengaluru (IN); Narayan KOTHARI, Bengaluru (IN)

(21) Appl. No.: 19/572,232

(22) Filed: Mar. 19, 2026

Related U.S. Application Data
(63) Continuation of application No. PCT/KR2026/002786, filed on Feb. 13, 2026.

(30) Foreign Application Priority Data
Feb. 24, 2025 (IN) 202541015879

(51) Int. Cl. G06T 5/70; G06T 5/60

(52) U.S. Cl. CPC G06T 5/70; G06T 5/60

(57) ABSTRACT

A system and method performed by an electronic device for generating a high-resolution image from an input low-resolution image are provided. The method includes determining one or more feature vectors for each of attributes associated with an input low-resolution image based on one or more image attributes, determining a degradation representation map of the input low-resolution image based on at least one of the input low-resolution image and the one or more feature vectors of the one or more image attributes, generating one or more personalization parameters based on at least one of the input low-resolution image and a user input, obtaining a first output image based on degradation information, a first process, and the one or more personalization parameters, obtaining a second output image based on the degradation information, a second process, and the one or more personalization parameters, and generating the high-resolution image by upsampling at least one of the first output image and the second output image.

### CROSS-REFERENCE TO RELATED APPLICATION(S)

This application is a continuation application, claiming priority under 35 U.S.C. § 365(c), of an International application No. PCT/KR 2026/002786, filed on Feb. 13, 2026, which is based on and claims the benefit of an Indian patent application number 202541015879, filed on Feb. 24, 2025, in the Indian Intellectual Property the disclosure of which is incorporated by reference herein in its entirety.

### BACKGROUND

### 1. Field

The disclosure relates to an enhancement in image processing. More particularly, the disclosure relates to a system and a method for generating a high-resolution image.

### 2. Description of Related Art

Super-resolution is a fundamental problem in low-level vision, aimed at generating a high-resolution (HR) image from an observed low-resolution (LR) image as input. This problem is inherently challenging due to its ill-posed nature, where a single LR image can correspond to multiple HR images, and an HR image can degrade into numerous LR representations depending on the types and levels of degradation it undergoes.

Super-resolution has emerged as a critical technique for improving the quality of LR images shared online or captured using smartphones. The primary expectation from any super-resolution solution is to effectively remove image degradations while preserving intricate details and enhancing the overall resolution. Diffusion models have gained popularity in image generation and manipulation.

Despite advancements, most existing super-resolution solutions fall short in their ability to address a wide range of image degradations. Training such solutions to generalize across diverse degradation types and simultaneously recover high-quality HR images is computationally challenging. Moreover, the improvements achieved through super-resolution depend heavily on a model's capacity to effectively remove underlying degradations while retaining critical image details.

Existing solutions often rely on complex models designed to jointly remove degradations and upsample the LR images to higher resolutions. However, these models are computationally expensive and pose significant challenges when deployed on resource-constrained platforms, such as smartphones. Furthermore, these solutions typically operate as black-box models with no provisions for user control, leaving user preferences unaddressed in the degradation removal process.

Traditional methods do not generalize to images from different domains, such as smartphones, DSLRs, and social networking sites (SNS). These methods do not utilize any prior information to adapt to input images from different domains and fail when the input image domain changes.

Some existing models are trained on a fixed degradation model and are unaware of the degradation present in user-input images. As a result, these models may produce outputs of arbitrary quality when the degradation in the input images is unknown.

The above is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and a method for generating a high-resolution image.

Additional aspects will be set forth in part in the description which follows and, in part, will be apparent from the description, or may be learned by practice of the presented embodiments.

In accordance with an aspect of the disclosure, a method for generating a high-resolution image is provided. The method includes determining, by the electronic device, one or more feature vectors for each of attributes associated with an input low-resolution image based on one or more image attributes, determining, by the electronic device, a degradation representation map of the input low-resolution image based on at least one of the input low-resolution image and the one or more feature vectors of the one or more image attributes, generating, by the electronic device, one or more personalization parameters based on at least one of the input low-resolution image and a user input, obtaining, by the electronic device, a first output image based on degradation information, a first process, and the one or more personalization parameters, obtaining, by the electronic device, a second output image based on the degradation information, a second process, and the one or more personalization parameters, and generating, by the electronic device, the high-resolution image by upsampling at least one of the first output image and the second output image.

In accordance with another aspect of the disclosure, a system for generating a high-resolution image is provided. The system includes memory, including one or more storage media, storing instructions, and at least one processor communicatively coupled to the memory, wherein the instructions, when executed by the at least one processor individually or collectively, cause the system to determine one or more feature vectors for each of attributes associated with an input low-resolution image based on one or more image attributes, determine a degradation representation map of the input low-resolution image based on at least one of input-low resolution image and one or more feature vectors, determine one or more personalization parameters based on at least one of the input low-resolution image and a user input, obtain a first output image based on degradation information, a first process, and the one or more personalization parameters, wherein the first process indicates removing a noise followed by a blur in a compression removed low-resolution image, obtain a second output image based on the degradation information a second process, and the one or more personalization parameters, wherein the second process indicates removing the blur followed by the noise in the compression removed low-resolution image, and generate the high-resolution image by upsampling at least one of the first output image and the second output image.

In accordance with another aspect of the disclosure, one or more non-transitory computer-readable storage media storing one or more computer programs including computer-executable instructions that, when executed by one or more processors of a system individually or collectively, cause the system to perform operations of generating a high-resolution image are provided. The operations includes determining one or more feature vectors for each of attributes associated with an input low-resolution image based on one or more image attributes, determining a degradation representation map of the input low-resolution image based on at least one of the input low-resolution image and the one or more feature vectors of the one or more image attributes, generating one or more personalization parameters based on at least one of the input low-resolution image and a user input, obtaining a first output image based on degradation information, a first process, and the one or more personalization parameters, obtaining a second output image based on the degradation information, a second process, and the one or more personalization parameters, and generating the high-resolution image by upsampling at least one of the first output image and the second output image.

Other aspects, advantages and salient features of the disclosure, will become apparent to those skilled in the art from the following detailed description, which, taken in conjunction with the annexed drawings, discloses various embodiments of the disclosure.

### BRIEF DESCRIPTION OF THE DRAWINGS

The above and other features, aspects, and advantages of certain embodiments of the disclosure will be more apparent from the following description taken in conjunction with the accompanying drawings, in which:

FIG. 1 illustrates an architecture for generating a high-resolution image according to an embodiment of the disclosure;

FIG. 2 illustrates personalization parameter estimation module in an architecture for generating a high-resolution image according to an embodiment of the disclosure;

FIG. 3 illustrates a dual path degradation module for generating a high-resolution image according to an embodiment of the disclosure;

FIG. 4A illustrates a degradation-free image estimation module according to an embodiment of the disclosure;

FIG. 4B illustrates a candidate degradation-free image estimation module when applied within a first modulated convolution block according to an embodiment of the disclosure;

FIG. 5 illustrates generating a plane image processing based upsampled image from low-resolution input using interpolation techniques and one or more personalization parameters according to an embodiment of the disclosure;

FIG. 6 illustrates a process of generating a upsampled image using a supervised learning approach using deep learning techniques for superior quality according to an embodiment of the disclosure;

FIG. 7 illustrates a process of generating a final upsampled image using a generative artificial model according to an embodiment of the disclosure;

FIG. 8 illustrates a block diagram of a system for generating a high-resolution image according to an embodiment of the disclosure; and

FIG. 9 illustrates a flowchart depicting a method for generating a high-resolution image according to an embodiment of the disclosure.

Throughout the drawings, like reference numerals will be understood to refer to like parts, components, and structures.

### DETAILED DESCRIPTION

The description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure in any way.

For example, any terms used herein, such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more element is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the disclosure will be described below in detail with reference to the accompanying drawings.

Throughout, the disclosure, the term “system” may refer to the overall messaging system or platform where the disclosure is implemented. It includes all the components necessary for sending, receiving, and managing messages.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

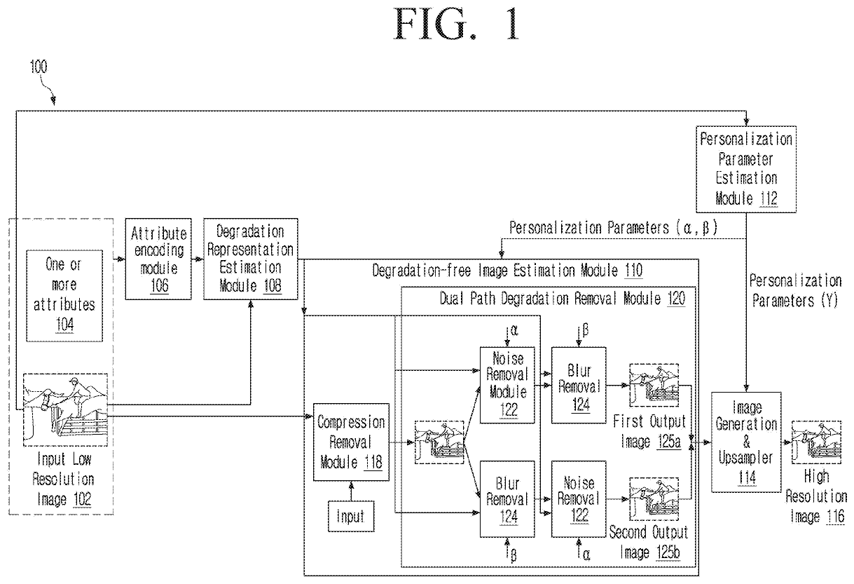

FIG. 1 illustrates an architecture for generating a high-resolution image according to an embodiment of the disclosure.

Referring to FIG. 1, an architecture 100 includes an input low-resolution image 102, one or more image attributes 104, an attribute encoding module 106, a degradation representation estimation module (DRE) 108, a degradation-free image estimation module 110, a personalization parameter estimation module 112, an image generation and upsampler 114, and an upsampled image 116. The degradation-free image estimation module 110 may further include a compression removal module 118 and a dual-path degradation removal module 120. The dual-path degradation removal module 120 may further include a noise removal module 122 and a blur removal module 124.

In an example, the input low-resolution image 102 may be an image with fewer pixels and may exhibit high levels of noise and blur. In an example, the upsampled image 116 may be an image having a higher pixel count with reduced noise and blur.

In operation, the attribute encoding module 106 may be configured to determine one or more feature vectors for each of the attributes associated with the input low-resolution image 102 based on one or more image attributes 104. The feature vector is determined based on encoding the one or more image attributes 104.

In an embodiment of the disclosure, the one or more feature vectors indicate one or more numerical values of the one or more image attributes 104. Further, the one or more image attributes 104 include one or more of an image compression format, ISO, source of capture, f-number, shutter speed, and exposure. The one or more image attributes 104 are determined based on determining at least one of an attribute or metadata information associated with the input low-resolution image 102.

For example, the user may capture a low-resolution image of a model using a user device, such as a smartphone. The one or more image attributes 104, such as ISO, shutter speed, and exposure settings, are stored in the metadata of the image. The one or more image attributes 104 encoding module 106 processes the one or more image attributes 104 and encodes them into the one or more feature vectors. For instance, if the image metadata indicates an ISO of 800, a shutter speed of 1/60s, and an f-number of 2.8, these values are numerically represented in a feature vector.

The one or more feature vectors created represent numerical values of the image's attributes, including its compression format and source of capture. For example, the encoding module identifies that the image was captured in JPEG format at ISO with a specific f-number and exposure setting. The one or more image attributes 104 are extracted from the image's metadata and represented numerically as part of the feature vector, which may be represented as [0.8, 0.016, 2.8, . . . ].

Upon determining the one or more feature vectors for each of the one or more image attributes associated with the input low-resolution image 102, the degradation representation estimation module 108 may be configured to determine a degradation representation map of the input low-resolution image 102. The degradation representation map of the input low-resolution image 102 may be determined based on based on at least one of the input low-resolution 102 image and the one or more feature vectors of the one or more image attributes 104.

For example, the degradation representation map may highlight areas in the input low-resolution image 102 where high levels of noise are present due to the high ISO setting and where blur occurs due to motion during capture. This degradation map serves as a guide for further processing.

Upon determining the degradation representation map of the input low-resolution image 102, the personalization parameter estimation module 112 may be configured to generate one or more personalization parameters based on at least one of the low-resolution image 102 and a user input. In an example, the user input may be a personalization preference, such as required brightness, resolution, and the like.

In an embodiment of the disclosure, the personalization parameter estimation module 112 may be configured to receive one or more user preferences as input from the user for every input low-resolution image 102. Upon receiving the one or more user preferences, the personalization parameter estimation module 112 may be configured to generate the one or more personalization parameters based on the one or more user preferences.

For example, the user, such as a photographer may specify that the final output should have higher brightness and a sharper resolution to enhance the subject's visibility in the photograph. Based on these preferences, the personalization parameter estimation module 112 may be configured to generate one or more parameters, such as a brightness adjustment value and a target resolution setting.

In another example, the one or more personalization parameters may indicate that for an outdoor portrait, the brightness should be increased by 20%, and the resolution should be optimized for large-screen displays. These inputs are used by the personalization parameter estimation module 112 to generate the high resolution images.

In one embodiment of the disclosure, the prior to generating the one or more personalization parameters, the personalization parameter estimation module 112 may be configured to display a one or more sampled representative images from a curated selection of images for a user feedback.

For example, before applying the one or more personalization parameters, the personalization parameter estimation module 112 may be configured to display sample images with various levels of brightness and sharpness adjustments. The user may select a sample that best matches their vision, such as an image with a slightly warmer tone and enhanced clarity. This feedback is used to finalize the one or more personalization parameters.

Once the personalization parameters are set, the input low-resolution image 102 may be transmitted to the compression removal module 118 to remove the compression in the input low-resolution image 102. The compression removal module 118 may be configured to remove the compression artefacts in the input low-resolution image 102 based on an estimated degradation representation map in the input low-resolution image 102. The compression artefacts corrected input low-resolution image 102 may then be used for obtaining a first output image 125a and a second output image 125b.

For example, once the personalization parameters are set, the compression removal module 118 may remove JPEG artifacts from the input image based on the degradation representation map. For instance, the compression removal module 118 may identify and smooth blocky patterns caused by compression, resulting in a compression corrected version of the image.

Upon determining the one or more personalization parameters, the dual path degradation removal module 120 may be configured to obtain the first output image 125a based on a degradation information, a first process, and the one or more personalization parameters. The first process indicates de-noising followed by a de-blurring in a compression-removed input low-resolution image 102. In an embodiment of the disclosure, the noise is removed by the noise removal module 122 and the blur is removed by the blur removal module 124.

The dual path degradation removal module 120 may be configured to obtain the second output image 125b based on degradation information, a second process, and the one or more personalization parameters. The second process indicates the de-noising followed by the de-blurring the compression-removed input low-resolution image 102. In an embodiment of the disclosure, the noise is removed by the noise removal module 122 and the blur is removed by the blur removal module 124.

For example, the dual path degradation module 120 upon receipt of the compression corrected input low-resolution image 102, may be configured to obtain the first output image 125a and the second output image 125b based on the degradation information.

In one embodiment of the disclosure, upon obtaining the first output image 125a and the second output image 125b, the image generation and upsampler 114 may be configured to generate the high-resolution image 116 by upsampling at least one of the first output image 125a and the second output image 125b. In an embodiment of the disclosure, the upsampling indicates increasing a resolution of the input low-resolution image 102 by adding one or more pixels.

In another embodiment of the disclosure, the upsampled high resolution image 116 may be generated using a generative artificial intelligence (AI) model. The generative AI model may be associated with the image generation and upsampler 114 is configured to receive the at least one of the first output image 125a, the second output image 125b, and the one or more personalization parameters. Upon receiving the first output image 125a, the second output image 125b, and the one or more personalization parameters, the image generation and upsampler 114 may be configured to upsample the at least one of the first output image 125a and the second output image 125b by a decoder in the generative AI model.

In an example, the generative AI model associated with the upsampler refines the first output image 125a and the second output image 125b. The generative AI model, such as a generative adversarial network (GAN), is configured to learn both upsampling and detail enhancement. The generative AI model uses an encoder-decoder architecture, where the decoder is asymmetric to facilitate upsampling to higher resolutions. The decoder's upsampling layers include “modulated upsample and convolutional blocks,” which integrate convolutional layers modulated by the personalization parameter γ\gamma. Thus, modulation allows the model to adaptively control its generative capability, fine-tuning the extent of detail enhancement in the final output.

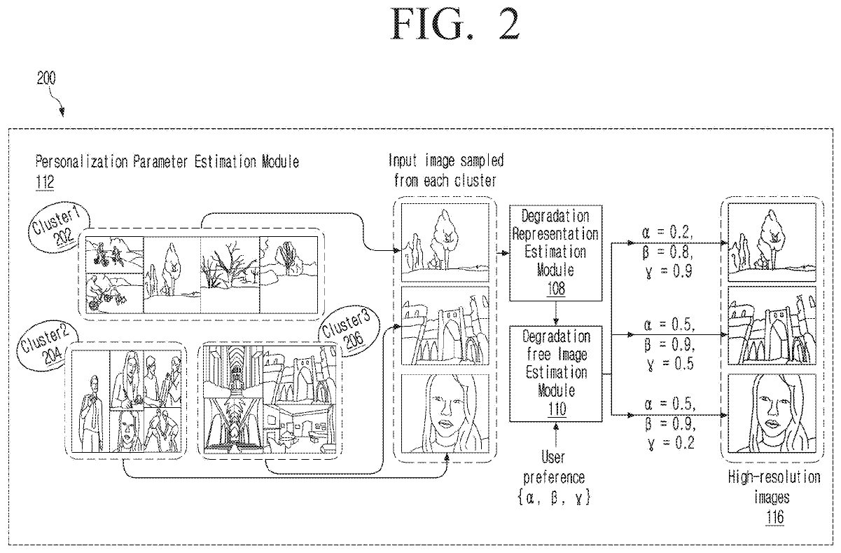

FIG. 2 illustrates personalization parameter estimation module in an architecture 200 for generating the high-resolution image, according to an embodiment of the disclosure.

Referring to FIG. 2, in an embodiment of the disclosure, the personalization parameter estimation module 112 may be configured to extract at least one of content encodings and style encodings. The content encodings represent semantic and structural elements, such as objects, shapes, and layouts in an image. The style encodings represent appearance attributes like textures, colors, lighting, and artistic details from the one more images in the training dataset.

Further, the one or more images in the training dataset are clustered into groups. In an example, the clustered group may include Cluster1 202, Cluster2 204, and Cluster 3 206 which represent perceptually similar content and style. Further, upon clustering the one or more images, a representative image is selected from each cluster to serve as a proxy for the cluster's overall characteristics.

Further, upon selecting each cluster as a proxy, the personalization parameter estimation module 112 may be configured to present representative images from each cluster to the user. Further, the user may then provide explicit feedback or the input by assigning the one or more personalization parameters (α, β, γ) to each image. The one or more personalization parameters (α, β, γ) reflect the user preferences for degradation correction, where α controls the balance between preserving or enhancing content, β addresses style preferences for example, smoothness or sharpness of textures, and γ adjusts other aesthetic priorities like brightness or contrast. For instance, a user might prefer sharper textures in images of buildings but smoother textures in portraits.

In an advantageous aspect, the user input or the feedback is critical because it allows the personalization parameter estimation module 112 to adapt to the user preferences dynamically. The personalization parameter estimation module 112 may be configured to extrapolate the one or more personalization parameters to broader clusters, ensuring the user preferences are applied to similar images across the dataset by gathering preferences for a small set of representative images. Furthermore, this approach minimizes the cognitive load on the user by requiring input for only a limited number of images while ensuring comprehensive personalization across all clusters.

The user-defined {α, β, γ} values (i.e., the one or more personalization parameters) are then fed into the degradation representation estimation module 108 and the degradation-free image estimation module 110. The degradation representation estimation module 108 may be configured to analyze the types and levels of degradations (e.g., noise, blur, or artifacts) in the input images. Next, the degradation-free image estimation module 110 may be configured to generate a set of images, each free of specific degradations. Finally, the image generation and upsampler 114 may be configured to combine the above using the user-provided parameters, resulting in a personalized output image (the high-resolution image 116) that aligns with the user's aesthetic and functional preferences.

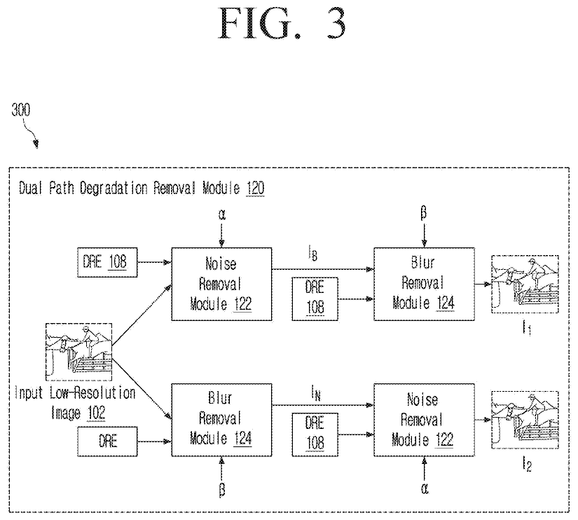

FIG. 3 illustrates a dual path degradation module in an architecture 300 for generating a high-resolution image according to an embodiment of the disclosure.

Referring to FIG. 3, the compression removed input image low-resolution image 102, containing both noise and blur, is processed through two distinct paths in all possible combinations. In the upper path, noise is first removed using the noise removal module 122, resulting in a noise-free image which is subsequently processed by the blur removal module 124 to remove blur and produce a degradation-free image. In the lower path, the blur removal module 124 first removes blur from the compression removed input low-resolution image 102, resulting in a blur-free image. This is followed by noise removal using the noise removal module 122 to produce the second degradation-free image.

Both the paths incorporate the degradation representation estimation (DRE) to account for the current degradation state. The one or more personalization parameters i.e., α\alpha and β\beta provided by the user or learnt by the persanlization parameter estimation module to control the extent of noise and blur removal, respectively. This dual-path strategy is necessary because noise removal (a low-pass filtering operation) alters the blur characteristics, and blur removal modifies high-frequency image details, affecting the noise degradation. The estimated DRE does not initially consider these changes in the blur and noise characteristics. Therefore, to compensate for these shifts in degradations and accurately account for them, the dual path degradation removal approach is employed.

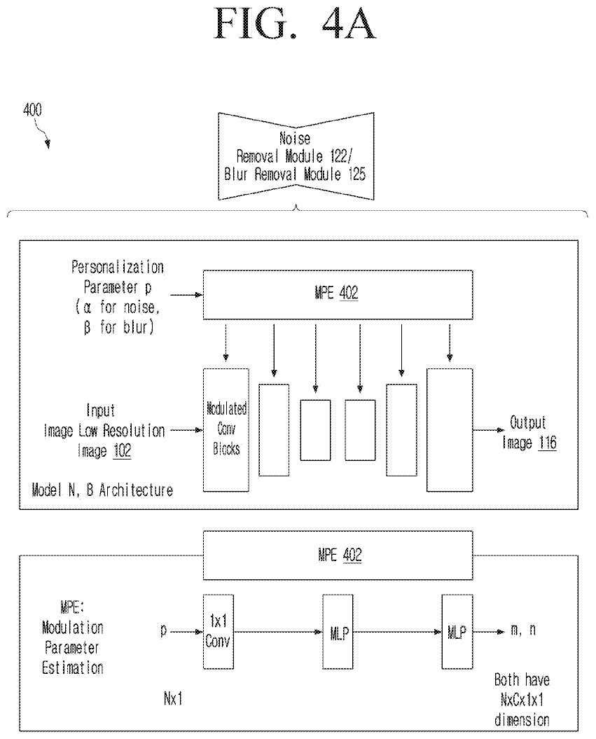

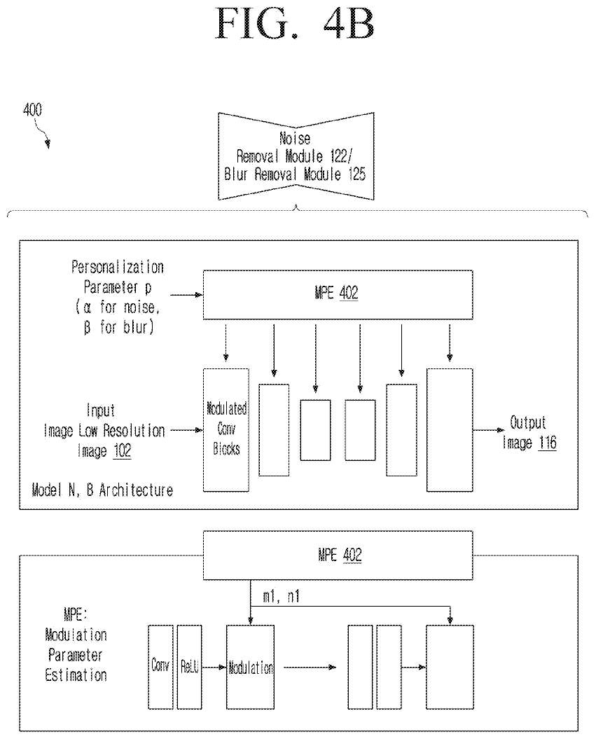

FIG. 4A illustrates a degradation-free image estimation module in an architecture 400 according to an embodiment of the disclosure.

Referring to FIG. 4A, the noise removal module 122 and the blur removal module 124 (N and B networks) take as input to a previously degradation-removed image, a degradation representation, and a personalization parameter (p), where α\alphaα is used for noise removal and β\betaβ for blur removal. The N and B networks may include modulated convolution blocks, each containing a convolution layer and an activation function, dynamically adjusted by estimated modulation parameters from the modulation parameter estimation (MPE) block 402. The MPE block 402 may be configured to compute modulation parameters mmm and nnn based on the personalization parameter ppp, using a 1×1 convolution layer followed by two multi-layer perceptrons (MLPs).

The modulation process applies an affine transformation to the feature map F from a convolution layer using the equation Fm=m*F+n, where m scales the feature map multiplicatively and n applies an additive bias. This modulation allows dynamic adaptation of convolution operations based on degradation type. The diagram consists of two parts: the top block presents the overall architecture, showing how input images pass through modulated convolution blocks with parameters from the MPE block, while the bottom block details the MPE computation flow, illustrating how the personalization parameter is processed to generate modulation parameters. This approach enhances adaptability by personalizing processing for noise and blur removal, ensuring degradation-free image estimation while maintaining computational efficiency.

FIG. 4B illustrates a candidate degradation-free image estimation module in an architecture 400 when applied within a first modulated convolution block according to an embodiment of the disclosure.

Referring to FIG. 4B, the input low resolution image 102, along with a personalization parameter p (α for noise, β for blur), is processed through modulated convolution blocks, dynamically adjusted using parameters estimated by the modulation parameter estimation (MPE) block 402. The lower section focuses on the first modulated convolution block, showing how the MPE block 402 may be configured to estimate affine parameters m1 and n1 for this layer.

The MPE block 402 may include a convolution layer, followed by ReLU activation, and then a modulation step where the feature map is transformed using the estimated parameters before passing through additional layers. A key distinction in the decoder is the use of transposed convolution layers instead of standard convolution layers. These transposed convolutions, also known as deconvolutions, may be configured to facilitate upsampling, aiding in the reconstruction of high-resolution features.

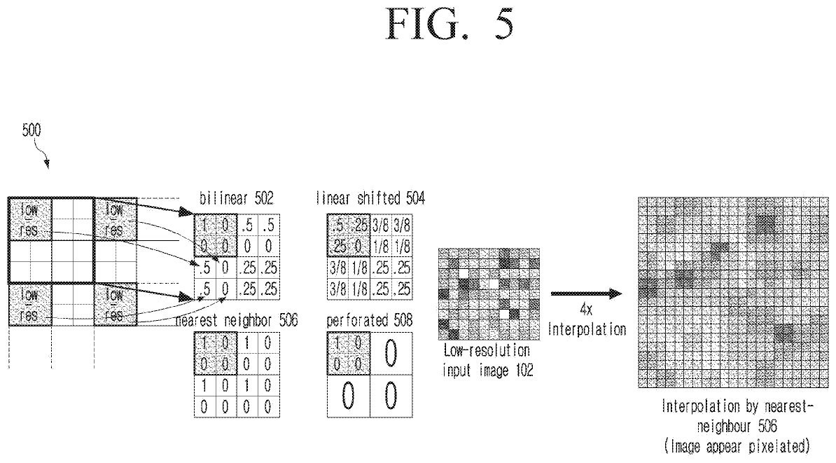

FIG. 5 illustrates a method 500 for generating a plane image from low-resolution input using interpolation techniques and one or more personalization parameters according to an embodiment of the disclosure.

Referring to FIG. 5, the interpolation techniques may include a bilinear interpolation 502, a linear shifted interpolation 504, a nearest neighbor interpolation 506, and a perforated interpolation 508. The interpolation techniques may be configured to fill the new pixel values generated during the upsampling process. The bilinear interpolation 502 may be configured to assign pixel values based on a weighted average of the neighboring low-resolution pixels. The linear shifted interpolation 504 may be configured to adjust the interpolation weights to introduce slight shifts, enhancing certain features. The nearest neighbor interpolation 506 may be configured to directly maps the closest pixel's value, leading to pixelated artifacts, as shown in the right-side image. The perforated interpolation 508 may be configured to demonstrate a sparse mapping approach with limited pixel replication. The personalization parameter γ\gamma allows the model to adaptively control the extent of detail enhancement and new information generation during upsampling.

This approach ensures that the upsampled image achieves higher spatial resolution and better visual quality than traditional analytic methods like bicubic and bilinear interpolation, which often lack the ability to add realistic details in the upscaled image. The final result integrates both the analytical interpolation process and the AI model's generative capabilities, producing a more refined and detailed high-resolution image 116 as output.

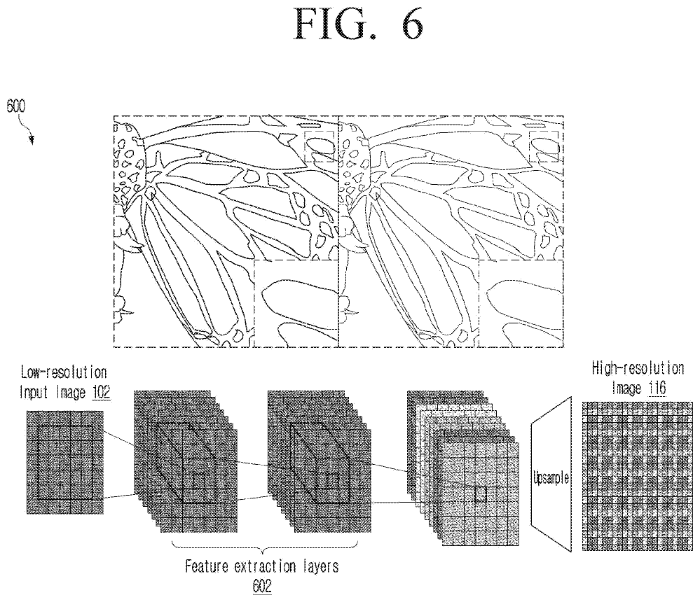

FIG. 6 illustrates a process 600 of generating a upsampled image using a supervised learning approach using deep learning techniques for superior quality according to an embodiment of the disclosure.

Referring to FIG. 6, the input to the supervised learning approach includes degradation-free images and the one or more personalization parameters, while the output is the final upsampled image i.e., the high-resolution image 116 with enhanced resolution and detail.

In contrast to basic interpolation techniques like bilinear or nearest-neighbor methods, the deep learning approach employs a trained model including multiple feature extraction layers 602, such as convolutional neural networks (CNNs). These layers extract rich and diverse representations of the low-resolution input image 102, significantly improving the upscaling performance. Unlike traditional interpolation methods that only utilize local pixel values, the deep learning approach progressively expands the receptive field of the network through successive layers, enabling it to capture broader contextual information across the entire image.

This feature extraction allows the network to interpolate missing pixel values in a more informed and accurate manner, resulting in a high-resolution image with greater fidelity and enhanced visual quality. The upsampling model achieves not only a significant improvement in spatial resolution but also the ability to adaptively enhance details and textures in the upscaled image by integrating the deep learning-based techniques with the one or more personalization parameters.

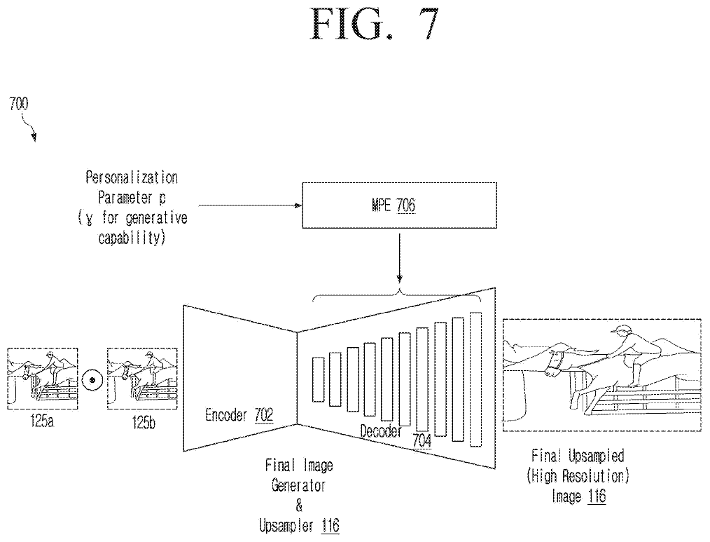

FIG. 7 illustrates a process 700 of generating a final upsampled image using a generative artificial intelligence (AI) model according to an embodiment of the disclosure.

Referring to FIG. 7, the final upsampled image i.e., the high resolution image 116 may be generated using the generative AI model associated with the image generator and upsampler 114. The input to the generative AI model associated with the image generator and upsampler 114 is the first degradation-free image (the first output image 125a), the second degradation free image (the second output image 125b), and the one or more personalization parameters. An MPE block 706 may be configured to compute modulation parameters.

The process uses the generative AI model, such as a generative adversarial network (GAN), configured to learn both upsampling and detail enhancement. The generative AI model uses an encoder 702 and decoder 704 architecture, where the decoder 704 is asymmetric to facilitate upsampling to higher resolutions. The decoder's upsampling layers include “modulated upsample and convolutional blocks,” which integrate convolutional layers modulated by the personalization parameter γ\gamma which allows the generative AI model to adaptively control its generative capability, fine-tuning the extent of detail enhancement in the final output.

The generative AI model not only interpolates missing pixel information but also generates realistic high-frequency details, producing a high-resolution image that exceeds the quality achievable by traditional methods. The combined use of generative modeling, personalization, and the designed training processes ensures that the upsampled image is both visually refined and contextually accurate.

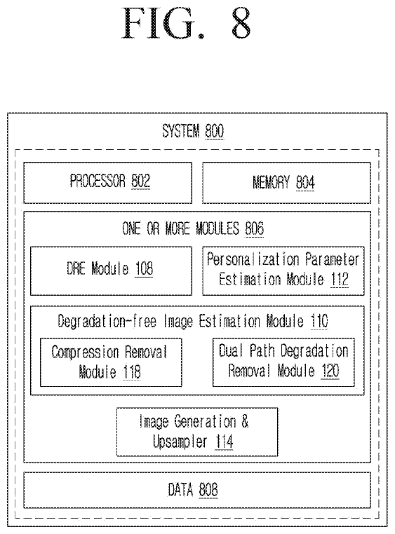

FIG. 8 illustrates a block diagram of a system 800 for generating a high-resolution image according to an embodiment of the disclosure.

Referring to FIG. 8, the system 800 may be implemented in the user device, such as smartphones.

In one embodiment of the disclosure, the system 800 may be configured to determine one or more feature vectors for each of the attributes associated with an input low-resolution image 102 based on one or more image attributes 104. The system 800 may further be configured to determine a degradation representation map of the input low-resolution image 102 based on at least one of the input low-resolution image 102 and the one or more feature vectors of the one or more image attributes. The system 800 may further configured to generate one or more personalization parameters based on at least one of the input low-resolution image 102 and an user input. The system 800 is further configured to obtain a first output image 125a based on degradation information, a first process, and the one or more personalization parameters. The first process indicates removing a noise followed by a blur in a compression removed input low-resolution image 102. The system 800 is further configured to obtain a second output image 125b based on the degradation information, a second process, and the one or more personalization parameters. The second process indicates removing the blur followed by the noise in the compression-removed input low-resolution image 102. The system 800 is further configured to generate the high-resolution image 116 by upsampling at least one of the first output image 125a and the second output image 125b.

The system 800 may include, but is not limited to, one or more processors 802, memory 804, one or more modules 806, and data 808. The one or more modules 806 and the memory 804 may be coupled to the one or more processor 802.

The one or more processor 802 can be a single processing unit or several units, all of which could include multiple computing units. The one or more processor 802 may be implemented as one or more microprocessors, microcomputers, microcontrollers, digital signal processors, central processing units, state machines, logic circuitries, and/or any devices that manipulate signals based on operational instructions. Among other capabilities, the one or more processors 802 are adapted to fetch and execute computer-readable instructions and data stored in the memory 804.

The memory 804 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The one or more modules 806, amongst other things, include routines, programs, objects, components, data structures, or the like, which perform particular tasks or implement data types. The modules 806 may also be implemented as, signal processor(s), state machine(s), logic circuitries, and/or any other device or component that manipulates signals based on operational instructions.

Further, the one or more modules 806 may be implemented in hardware, instructions executed by a processing unit, or by a combination thereof. The processing unit can comprise a computer, a processor, such as the one or more processor 802, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In another embodiment of the disclosure, the one or more modules 806 may be machine-readable instructions (software) which, when executed by a processor/processing unit, perform any of the described functionalities.

In an embodiment of the disclosure, the one or more modules 806 may include the degradation representation estimation (DRE) module 108, the personalization parameter estimation module 112, the degradation-free image estimation module 110, and the image generation & upsampler 114. The degradation-free image estimation module 110 may further comprises of the compression removal module 118 and the dual path degradation removal module 120.

In an embodiment of the disclosure, the degradation representation module 110 may be configured to determine the degradation representation map of the input low-resolution image 102 based on at least one of the input low-resolution image 102 and the one or more feature vectors of the one or more image attributes 104. The one or more feature vectors indicates one or more numerical values of the one or more image attributes 104. The one or more image attributes 104 include one or more of an image compression format, ISO, source of capture, f-number, shutter speed, and exposure. The one or more image attributes 104 are determined based on determining at least one of an attribute or metadata information associated with the input low-resolution image 102.

In an embodiment of the disclosure, the personalization parameter estimation module 112 may be configured to generating one or more personalization parameters based on at least one of the input low-resolution image 102 and an user input. The personalization parameter estimation module 112 may be further configured to receive the one or more user preferences as input from the user for every input low-resolution image 102. The personalization parameter estimation module 112 may be configured to generate the one or more personalization parameters based on the one or more user preferences.

In an embodiment of the disclosure, the degradation-free image estimation module 108 may be configured to obtain the first output image 125a based on the degradation information, the first process, and the one or more personalization parameters. The first process indicates removing the noise followed by the blur in the compression removed input low-resolution image 102. The degradation-free image estimation module 110 may be further configured to obtain the second output image 125b based on the degradation information, the second process, and the one or more personalization parameters. The second process indicates removing the blur followed by the noise in the compression-removed input low-resolution image 102.

In an embodiment of the disclosure, the compression removal module 118 may be configured to remove the compression in the input low-resolution image 102 based on the estimated degradation representation map in the input low-resolution image 102.

In an embodiment of the disclosure, the dual path degradation module 120 may be configured to remove the noise followed by the blur in the compression removed input low-resolution image 102. In another embodiment of the disclosure, the dual path degradation module 120 may be configured to remove the blur followed by the noise in the compression removed input low-resolution image 102.

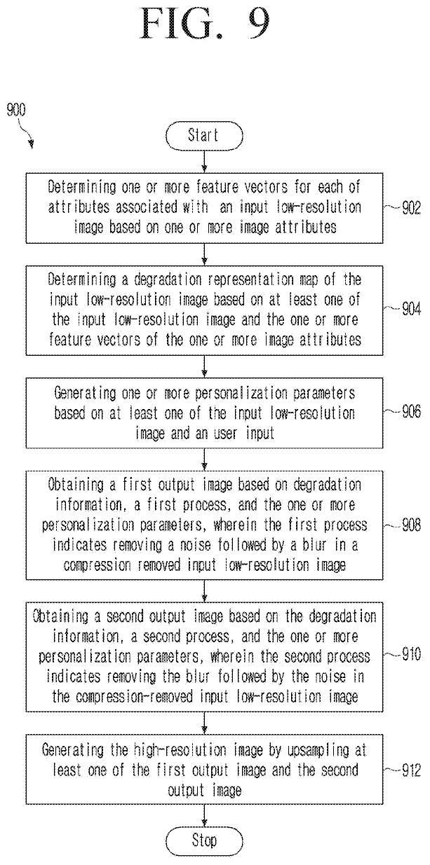

FIG. 9 illustrates a flowchart depicting a method 900 for generating a high-resolution image according to an embodiment of the disclosure.

Referring to FIG. 9, at operation 902, the method 900 may include generating one or more feature vectors for each attribute associated with an input low-resolution image 102 by extracting information from one or more image attributes 104.

At operation 904, the method 900 may include generating a degradation representation map of the input low-resolution image 102 by leveraging at least one of the input low-resolution image 102 and the feature vectors associated with the image attributes to model the degradation characteristics.

At operation 906, the method 900 may further include deriving one or more personalization parameters by utilizing at least one of the input low-resolution image 102) and user input data.

At operation 908, the method 900 may include acquiring a first output image 125a based on degradation information, a primary processing sequence, and the one or more personalization parameters. The primary processing sequence includes noise reduction followed by blur application to a compression-affected input low-resolution image 102.

At operation 910, the method 900 may include generating a second output image 125b using degradation information, a secondary processing sequence, and the one or more personalization parameters. The secondary processing sequence involves removing the blur followed by noise reduction in the compression-processed input low-resolution image 102.

At operation 912, the method 900 may further include creating the high-resolution image by upsampling one or both of the first output image 125a and the second output image 125b.

The disclosure advantageously overcomes one or more technical problems associated with the existing systems, such as:

Firstly, the disclosure may improve the overall image quality by determining feature vectors associated with various image attributes and modeling the degradation of the input image, the method restores clarity and sharpness, resulting in a more accurate high-resolution output.

The disclosure allows for personalization based on user input, enabling the generation of images that are tailored to specific needs or aesthetic preferences. This flexibility makes the system highly customizable, ensuring that the final result aligns with individual requirements.

The disclosure allows for effectively addresses common issues in low-resolution images, such as noise and blur. By employing a two-step process that removes noise and blur in different sequences, the system ensures that these undesirable elements are minimized, leading to a cleaner and more visually appealing high-resolution image.

The disclosure is capable of compensating for image degradation. By understanding how the low-resolution image has been affected, the method can reverse or mitigate these effects, producing a high-resolution image that more closely resembles the original. This approach improves the accuracy of the image restoration process

The disclosure ensures to adapt to different types of image degradation, whether caused by noise or blur, by applying the most suitable enhancement steps to achieve optimal results. Additionally, the method benefits from an efficient upsampling process that combines outputs from different processing paths, enhancing image quality and ensuring better resolution compared to traditional methods. The system also addresses compression artifacts, a common issue in low-resolution images, by specifically targeting and removing them, resulting in a more accurate high-resolution image. Furthermore, the streamlined process enables fast image restoration, making it ideal for time-sensitive or large-scale applications.

The disclosure ensures that the ability to personalize the results based on user input adds another layer of value, giving users more control over the final output. This makes the system highly versatile, capable of being used in a wide range of applications, from entertainment to professional fields, such as medical imaging or satellite imagery.

Further numerous advantages of the disclosure include a user-centric approach, efficiency enhancement, adaptability to user behaviour, competitive advantage, alignment with industry trends, market differentiation, and future-proofing capabilities.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for generating a high-resolution image, the method comprising:
determining, by the electronic device, one or more feature vectors for each of attributes associated with an input low-resolution image based on one or more image attributes;
determining, by the electronic device, a degradation representation map of the input low-resolution image based on at least one of the input low-resolution image and the one or more feature vectors of the one or more image attributes;
generating, by the electronic device, one or more personalization parameters based on at least one of the input low-resolution image and a user input;
obtaining, by the electronic device, a first output image based on degradation information, a first process, and the one or more personalization parameters;
obtaining, by the electronic device, a second output image based on the degradation information, a second process, and the one or more personalization parameters; and
generating, by the electronic device, the high-resolution image by upsampling at least one of the first output image and the second output image.

2. The method of claim 1, wherein the one or more feature vectors indicates one or more numerical values of the one or more image attributes.

3. The method of claim 1, wherein the upsampling indicates increasing a resolution of the input low-resolution image by adding one or more pixels.

4. The method of claim 1, wherein prior to obtaining the first output image, the method further comprises:
removing compression in the input low-resolution image based on an estimated degradation representation map in the input low-resolution image.

5. The method of claim 1, wherein the one or more image attributes include one or more of an image compression format, ISO, source of capture, f-number, shutter speed, or exposure.

6. The method of claim 1, wherein the one or more image attributes are determined based on determining at least one of an attribute or metadata information associated with the input low-resolution image.

7. The method of claim 1, wherein the one or more feature vectors are determined based on encoding the one or more image attributes.

8. The method of claim 1, wherein the degradation representation map of the input low-resolution image includes one or more of compression, a blur, or noise degradations.

9. The method of claim 1, wherein the generating of the one or more of personalization parameters comprises:
receiving one or more user preferences as input from the user for every input low-resolution image; and
generating the one or more personalization parameters based on the one or more user preferences.

10. The method of claim 9, wherein prior to generating the one or more personalization parameters, the method further comprises:
displaying a one or more sampled representative images from a curated selection of images for a user feedback.

11. The method of claim 1,
wherein the high-resolution image is generated using a generative artificial intelligence (AI) model, and
wherein the method further comprises:
receiving the at least one of the first output image, the second output image, and the one or more personalization parameters; and
upsampling the at least one of the first output image and the second output image by a decoder in the generative AI model.

12. The method of claim 1, wherein the first process indicates removing a noise followed by a blur in a compression removed input low-resolution image.

13. The method of claim 1, wherein the second process indicates removing a blur followed by noise in a compression-removed input low-resolution image.

14. A system for generating a high-resolution image, the system comprising:
memory, comprising one or more storage media, storing instructions; and
at least one processor communicatively coupled to the memory,
wherein the instructions, when executed by the at least one processor individually or collectively, cause the system to:
determine one or more feature vectors for each of attributes associated with an input low-resolution image based on one or more image attributes,
determine a degradation representation map of the input low-resolution image based on at least one of input-low resolution image and one or more feature vectors,
determine one or more personalization parameters based on at least one of the input low-resolution image and a user input,
obtain a first output image based on degradation information, a first process, and the one or more personalization parameters, wherein the first process indicates removing a noise followed by a blur in a compression removed low-resolution image,
obtain a second output image based on the degradation information a second process, and the one or more personalization parameters, wherein the second process indicates removing the blur followed by the noise in the compression removed low-resolution image, and
generate the high-resolution image by upsampling at least one of the first output image and the second output image.

15. The system of claim 14, wherein the one or more feature vectors indicates numerical values of the one or more image attributes.

16. The system of claim 14, wherein the upsampling indicates increasing a resolution of the input low-resolution image by adding one or more pixels.

17. The system of claim 14, wherein prior to obtaining the first output image, the instructions, when executed by the at least one processor individually or collectively, further cause the system to:
remove compression in the input low-resolution image based on an estimated degradation representation map in the input low-resolution image.

18. The system of claim 14, wherein the one or more image attributes include one or more of an image compression format, ISO, source of capture, f-number, shutter speed, or exposure.

19. One or more non-transitory computer-readable storage media storing one or more computer programs including computer-executable instructions that, when executed by one or more processors of a system individually or collectively, cause the system to perform operations of generating a high-resolution image, the operations comprising:
determining one or more feature vectors for each of attributes associated with an input low-resolution image based on one or more image attributes;
determining a degradation representation map of the input low-resolution image based on at least one of the input low-resolution image and the one or more feature vectors of the one or more image attributes;
generating one or more personalization parameters based on at least one of the input low-resolution image and a user input;
obtaining a first output image based on degradation information, a first process, and the one or more personalization parameters;
obtaining a second output image based on the degradation information, a second process, and the one or more personalization parameters; and
generating the high-resolution image by upsampling at least one of the first output image and the second output image.

20. The one or more non-transitory computer-readable storage media of claim 19, wherein the one or more feature vectors indicates one or more numerical values of the one or more image attributes.
